(19) United States
(12) Patent Application Publication
(10) Pub. No.: US 2007/0219310 A1
(43) Pub. Date: Sep. 20, 2007

(54) Paint ready sprayable material

(76) Inventor: John R. Woods, Woodland Hills, CA (US)

Correspondence Address: PILLSBURY WINTHROP SHAW PITTMAN LLP, P.O BOX 10500, McLean, VA, 22102, US

(21) Appl. No.: 11/378,864

(22) Filed: Mar. 17, 2006

(51) Int. Cl. C08L 29/04

(52) U.S. Cl. 524/557

(57) ABSTRACT

A sprayable material used to patch drywall or other like areas in the form of a sprayable composition includes a base, a filler, an adhesive binder, an anti-foaming agent, a suspension agent, and a sealant. The material is storable and dispensable from a pressurized dispenser having a delivery nozzle. An aerosol system with a spray nozzle is included on the container for selective discharge of the sprayable material onto a surface to be coated, which may be a drywall or support panel so that the final paint coating may be applied directly onto the coating of the sprayable material.

### FIELD OF THE INVENTION

1. Field of the Invention

This invention relates generally to sprayable surface materials, and more particularly to a pressurized substance in liquid or semi-liquid form that is storable and dispensable from an air-tight pressurized container to be sprayed onto a drywall or supporting surface so that after subsequent curing and hardening, a final paint coating may be applied directly thereon. The “paint ready” sprayable material composition includes a sealant so that the sealant is applied simultaneously with the spraying of the coating or patching material.

2. Description of Related Art

It has been the conventional practice in the procedure of painting or repairing drywall or other like areas to apply several layers of surface material. For example, after the coating or patch material has cured and adhered to the original support material, a primer is generally applied before the surface receives the final coating. This is a time-consuming process.

Furthermore, in surfaces such as acoustic ceilings, there is an added problem with patching the repair area so that the appearance matches the textured surrounding areas. This involves another additional step of manipulating the patched area so that the same textured surface results.

Thus, there have been developed sprayable texture materials that can be conveniently used to repair or patch drywall or other like surfaces in a manner that provides a repair area that visually assumes the surface texture of the surrounding wall area. U.S. Pat. No. 6,386,4025, to the present Applicant, discloses a sprayable drywall texture that is sprayable from a hand-held aerosol dispenser and is hereby incorporated in its entirety.

However, there is still a need to reduce the number of steps and time it takes for reaching the final coating of paint. One such common step is the separate application of a sealant over the sprayable paint or patch material after the material is applied. The sealant serves to coat and seal in the sprayable material and to prime the layer for the final layer of paint. Applying a layer of sealant is especially important when the final layer of paint is of a dark color. The priming aids to give the paint better coverage properties, as well as keep the color true to its formula. Painting over an unprimed surface can effect the look of any color. Thus, it is very important to include a step of applying the sealant to prevent such occurrences. This separate step, while important, is time-consuming because it requires the user to wait for the applied patch material to dry and set. Moreover, after the sealant is applied over the sprayable paint or patch material, the user is required to wait yet again for the sealant to set before finally applying the paint.

Therefore, there is a need for an sprayable material that may be applied to a coated or repaired area, and that may be contained in a hand-held applicator and dispensed using propellants, in a simple and more efficient manner.

### BRIEF SUMMARY OF THE INVENTION

In accordance with embodiments of the invention, an object of an embodiment of the present invention is to provide a paint ready sprayable surface material used for coating or patching that is storable and dispensable from a hand-held dispensing unit for spray-on and direct application of the material in a liquid or semi-liquid form onto a surface to be coated or repaired, and further includes a sealant to reduce the number of steps required to finish repairing the drywall area.

Accordingly, the above problems and difficulties are avoided by the present invention, which generally provides a sprayable material that is storable and dispensable from a convenient dispenser including a pressurized container holding a quantity of the sprayable material in a liquid or semi-liquid condition so that upon depression of a dispensing nozzle, the material will be discharged and directed to an area intended to receive the surface material. The material flows through the dispensing nozzle and is applied as an aerosol spray. The material is capable of hardening after application so as to coat a surface or fill in and patch an area of repair. This hardenable flowable material includes a base, a filler, an adhesive binder, an anti-foaming agent, a suspension agent, a sealant, and an aerosol propellant, preferably a VOC propellant, that serves as a carrier medium and a pressure source so that the hardenable flowable material may be applied by spray and will adhere to the substrate. In embodiments, fibrous materials, that do not decompose in the presence of VOC propellants, may be include to provide an applicable material for coating or repairing ceilings. For example, such fibrous materials help provide the texture to match the surface of the ceiling surrounding the area of repair. The fibrous materials may include, but are not limited to, polypropylene fibers, polyethylene fibers, plastic fibers, cotton fibers, natural fibers, and synthetic fibers. In place of the fibrous materials, an aggregate, made of rubber particulates or polyethylene particulates, that does not decompose in the presence of VOC propellants, may be used.

The term “hardenable flowable material” is used interchangeably with the term “sprayable material.”

In an embodiment of the present invention, the paint ready sprayable material is used for coating drywall surface areas. After spraying, the material forms a coat that can be painted directly. The sprayable material may include: a base or emulsion of water and/or solvent; an adhesive binder made of a natural or synthetic polymer; a pressurized carrier for dispensing of the material, such as a solvent/propellant aerosol that mixes with the composition; a filler made of a mixture of calcium-carbonate (limestone), mica, or clay; and a sealer or sealant for priming the applied sprayable material. The selected sealant does not change the applicability of the sprayable material or the quality of the resulting coat formed. The sealant is dispensed in aerosol form and is sprayed together with the material, rather than applied manually.

Optionally, there may be included fibrous materials that clump together to form particulates that help produce the irregular texture effect for acoustic ceilings. The aggregate may comprise rubber particulates or polyethylene-type particulates (that are not dissolvable in solvent or solvent propellants, such as dimethyl ether (DME), propane, or butane) that help produce the irregular texture effect for acoustic ceilings. Furthermore, the rubber or polyethylene particulates, being of a soft and deformable material, allow for an easier flow through the valves and nozzles of the dispensing container because they are deformable and bend within the valves and nozzles upon dispensing.

### BRIEF DESCRIPTION OF THE DRAWINGS

A detailed description of embodiments of the invention will be made with reference to the accompanying drawings, wherein like numerals designate corresponding parts in the figures.

FIG. 1 illustrates the direct application of the spray-on surface material from the dispenser for repairing of a piece of drywall according to an embodiment of the invention.

FIG. 2 illustrates the direct application of the spray-on surface material from the dispenser for the patching or smoothing of a seam between two pieces of drywall in accordance with an embodiment of the present.

FIG. 3 illustrates a transverse cross-sectional view of the repaired or patched area shown in FIG. 1 showing the dissimilarity in surface texture between the original drywall surface and the surface of the patched areas.

FIG. 4 illustrates a transverse cross-sectional view of the repaired or patched area on a piece of drywall and shows matching of surface texture between the surface of the patch and the surrounding drywall surface after use of the sprayable material according to embodiments of the invention.

### DETAILED DESCRIPTION OF THE INVENTION

In the following description, reference is made to the accompanying drawings which form a part hereof and which illustrate several embodiments of the present inventions. It is understood that other embodiments may be utilized and structural and operational changes may be made without departing from the scope of the present inventions.

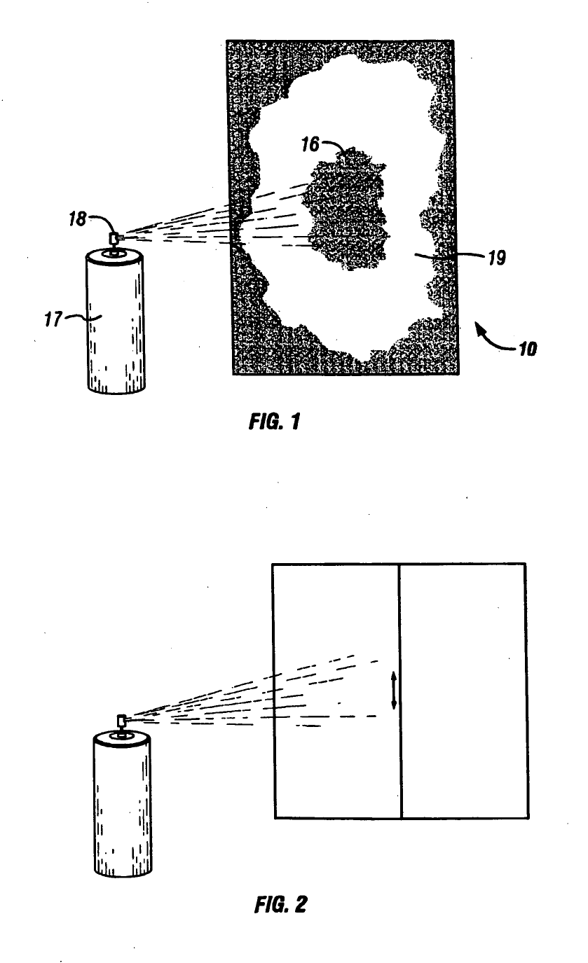

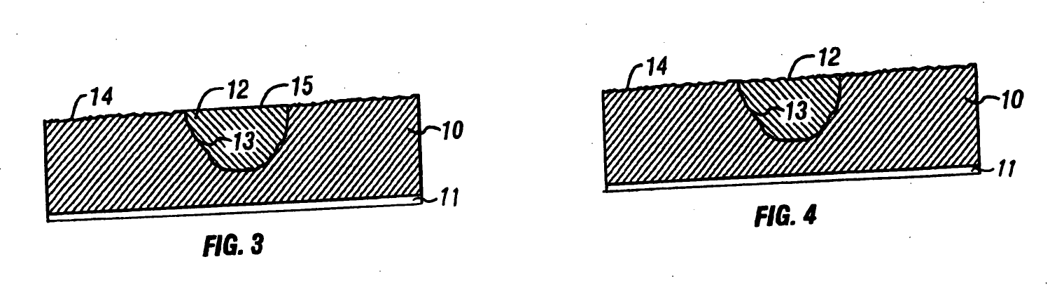

As shown in FIG. 1, and referring in detail to FIGS. 3 and 4, the paint ready sprayable surface material 16 discharged from a dispenser 17 is illustrated as being applied to the surface 15 of patch 12. In this manner, a coating is placed on the surface 15 so as to be compatible with, blend with and be coextensive with the surrounding surface area 14. The material being applied is broadly indicated by numeral 16 which is contained within the dispenser 17 and applied in the form of a spray in either liquid or semi-liquid condition.

In one embodiment of the present invention, shown in FIG. 1, application is achieved by depression of a pump or spray nozzle which permits discharge of the pressurized material carried within the container 17. Such an application of the material 16 occurs directly on the desired area 19 by the user who hand-carries the container 17 and operates the nozzle 18 on the site with one hand. Waste and loss of material is avoided since the discharge is under the control of the user through the application of the discharge nozzle 18. Therefore, there is no residue or excess material that is not used which requires disposal. Furthermore, in embodiments, the material 16 may be slightly lumpy and, after curing on the desired surface 19, provides an irregular surface that is slightly roughened and compatible and matching the surrounding material surface area, such as for example, an acoustic surface. Additionally, the material in the container is considered a finished product and does not require additives of any kind. The labeling on the container may provide identification numbers and laboratory information.

In an alternate embodiment of the present invention, the quick-dry aqueous material may be applied through the use of traditional spray dispensers as are known in the art.

Referring in detail to FIGS. 3 and 4, a fragmentary view is shown of a typical piece of drywall and is identified by the number 10. It is also shown that the drywall panel 10 may be supported by boards or other means of support 11, although this is not always the case. The drywall has been damaged and a repair to the damaged area has been performed in the form of a patch 12. In alternative embodiments, the patch can also be applied to a seam between two pieces of drywall. After curing, the patch becomes solidified and adheres to the edge marginal region of support material 11 or the edge marginal region of damaged area 13. The repaired surface area of the drywall 14 can be seen to be uniform with the slightly roughened surface of the surrounding drywall material 10.

In FIG. 3, it can be seen that the patch 12 displays a smooth surface 15 usually attained by repeatedly drawing the edge of a hand tool, such as a trowel, across the surface. After drying or curing, the material of the patch 12 becomes hard and the surface 15 remains smooth and in some cases unmatched with the surrounding slightly roughened surface 14 carried on the drywall panel 10. Although the surface 15 will accept a variety of coatings such as paint or the like in a conventional situation, the surface texture of the coating will not simulate or blend with the surrounding irregular surface 14 of original material 10. Visually, flat patch area 15 will always be noticeable and indicate the presence of a repair.

After application of the paint ready sprayable material, in all above embodiments, the user may next apply the final paint coating directly over the material once it dries and sets. The sealer or sealant included in the composition primes the repaired area so that it is ready for painting. The inclusion of a sealer or sealant in the sprayable material composition allows a more efficient system of repair for a support drywall are or other like surface. Generally, the sealant is applied separately after the sprayable material is applied. This step requires that the user wait for the sprayable material itself to dry and set before applying the layer of sealant. Next, the user must wait again for the sealant to dry and set in order for the sprayable material to be properly primed. Then finally, the paint coating can be applied to the area. Because embodiments of the present invention include the sealant in the composition, however, the sealant is applied at the same time the material is applied to the desired area. Consequently, the inclusion of the sealant virtually eliminates the commonly required step of applying a separate sealant over the patched area. In this manner, there is no need to wait for a separate layer of sealant to be applied and dried over the sprayable material before finishing with the final paint coating. Thus, additional waiting time involved in such a procedure is significantly reduced.

As illustrated in FIGS. 1 and 2, the material 16 is applied directly to the surface 15 and when dried or cured results in a coating ready to receive the final coating of paint. In FIG. 4, is shown that the material 12 applied includes fibrous materials and forms a slightly roughened surface having a texture compatible and matched with the surrounding surface texture of the drywall. The patch material 12 is dried and cured in preparation for receiving the final paint coating. Even if small amounts of the material extend beyond the surface 15 onto the surrounding material, the surface would still be matched and no unsightly patch edges or dissimilar surface texture would be detectable. The material may also be used to mask a rough patch job done by other methods.

Preferably, an example of the sprayable material comprises an aqueous base, filler, a polymer and a small amount of acetone. The filler may be calcium carbonate, clay or similar materials, or mixtures thereof. The acetone, which provides few noxious fumes and has low toxicity, may serve to facilitate an even spray and quick drying.

By way of an example, the hardenable flowable material 16 of the present invention may have the following composition by percentage weight:

| | |
|---|---|
| Liquid Base | 20-60% |
| Filler | 37-77% |
| Natural or Synthetic Polymer | 3-10% |
| Sealant | 5-40% |

Another example of the hardenable flowable material 16 comprises a liquid base, a filler, an adhesive binder, a propellant, an anti-foaming agent, a suspension agent, a sealer or sealant and optionally fibrous materials. The liquid base may be any aqueous substance such as water and/or a non-aqueous substance such as alcohol, aromatic or aliphatic hydrocarbons, ketones, esters or the like. The filler may be any material that can serve as an extender or bodifier such as limestone, clay, mica, silica, or similar materials, or a mixture thereof. The filler may also be made of a paint-based material. The adhesive binder is an adhesive that may take the form of a natural polymer, such as gums and resins and the like, or a synthetic polymer, such as polyvinyl alcohol, polyvinyl acetate, acrylic polymers, alkyd resins, etc., or a combination thereof. The adhesive binder will serve to keep the material 16 in place once it has cured. The propellant will act to push or propel the material 16 from the container. The propellant may be hydrocarbon, dimethyl ether, propane, butane, carbon dioxide, nitrogen, compressed gas or any combination of the above said propellants or any other propellant used in the aerosol industry, such as hydrofluorocarbons. However, the propellant is preferably a VOC propellant, and most preferably a dimethyl ether (DME) propellant. The anti-foaming agent is preferably a silicone anti-foaming agent, such as WICHENOL or Dow Corning ANTIFOAM A or B. Alternatively, an organic anti-foaming agent, or an anti-foaming agent that is a mixture of silicone and organic, may be used. The suspension agent is preferably carbonal or a cellulose ether, such as METHOCEL. The sealant may generally be urethane-based, cellulose-based, acrylic-based, silicon-based, or any other like resins that act as sealants used in the art. For example, TEFLON or one-component urethane. The selected sealant does not change the applicability of the sprayable material or the quality of the resulting coat formed. The sealant is dispensed in aerosol form and is sprayed together with the material, rather than applied manually. In a preferred embodiment, acrylic urethane is the sealant. The optional fibrous materials are incorporated with the other materials to provide the irregular texture to the material 15, such as for example, to use for acoustic ceilings. The fibrous materials are preferably selected from the group consisting of, but not limited to, polypropylene, polyethylene, plastics, cotton, natural fibers, and synthetic fibers. While it is preferable to use fibrous materials that will not deteriorate or melt in the presence of VOC propellants, it is also possible to use fibrous materials that will deteriorate or melt in the presence of VOC propellants, in which case it is preferable to use a non-VOC propellant.

The use of fibrous materials in the hardenable flowable material, or of rubber particulates or polyethylene particulates as the aggregate, allows the hardenable flowable material to be sprayed in the presence of volatile organic compound (VOC) propellants. As noted above, it is within the scope of the present invention to use fibrous particulates that are subject to decomposition in the presence of VOC propellants. It should be realized by one of ordinary skill in the art that if the selected fibrous materials will decompose or melt in the presence of VOC propellants, it would be preferable to use a non-VOC propellant. Other materials, such as STYROFOAM, will deteriorate and melt in the presence of VOC propellants. Therefore, when using such materials, one must use compressed air or other non-VOC propellants, which requires an increased pressure to propel these materials. The increased pressure also reduces the desired level of atomization and the level of control for the user when spraying. The increased pressure also forces the sprayable texture material to be dispensed all at once in a matter of seconds, which offers the user little value.

In an alternate embodiment, the material 16 comprises a liquid base, a filler, an adhesive binder, a propellant, an anti-foaming agent, a suspension agent, and a sealer or sealant. The liquid base may be any aqueous substance such as water and/or a non-aqueous substance such as alcohol, aromatic or aliphatic hydrocarbon, ketone, ester or the like. The filler may be any material that can serve as an extender or bodifier such as limestone, clay, mica, or silica, or similar materials, or a mixture thereof. The filler may also be made of a paint-based material. The adhesive binder is an adhesive that may take the form of a natural polymer, such as gums and resins and the like, or a synthetic polymer, such as polyvinyl alcohol, alkyd resins, etc., or a combination thereof. The adhesive binder will serve to keep the material 16 in place once it has cured. The propellant will act to push or propel the material from the container. The propellant may be hydrocarbon, dimethyl ether, propane, butane, carbon dioxide, nitrogen, compressed gas or any combination of the above said propellants or any other propellant used in the aerosol industry, such as hydrofluorocarbons. However, the propellant is preferably a VOC propellant. The anti-foaming agent is preferably WICHENOL or Dow Corning ANTIFOAM A and B. The suspension agent is preferably a material such as carbonal. The sealer or sealant can be TEFLON, acrylic urethane or one-component urethane. The sealant may also be urethane-based, cellulose-based, acrylic-based, silicon-based, or any other like sealants used in the art.

The inclusion of a sealer or sealant in the sprayable material composition allows a more efficient system of repair for a support drywall. There is no need to wait for a separate layer of sealant to be applied and dried over the sprayable material before finishing with the final paint coating, and additional waiting time involved in such a procedure is significantly reduced. The sealant may be present in the sprayable material composition in an amount of about 5 to 40% by weight. In alternative embodiments, the sealant may be present in the sprayable material composition in an amount of about 10 to 20% by weight. The sealant may be of either an oil or water-based composition. The sealer or sealant can be TEFLON, acrylic urethane or one-component urethane. The sealant may also be urethane-based, cellulose-based, acrylic-based, silicon-based, or any other like sealants used in the art.

By way of an example, the hardenable flowable material 16 of the present invention may have the following composition by percentage weight:

| | |
|---|---|
| Water/Solvent | 10-60% |
| Filler | 25-70% |
| Binder | 1-50% |
| Liquefied Propellant | 5-20% |
| (that mixes with the compound) | |
| Aggregate or Fibrous Materials | 2-40% |
| (for use for acoustic ceilings) | |
| Anti-Foaming Agent | 1-10% |
| Suspension Agent | 1-20% |
| Sealant | 5-40% |

Also by way of a more specific example, the hardenable flowable material 16 of the present invention may have the following composition by percentage weight:

| | |
|---|---|
| Water/Solvent | 20-40% |
| Filler | 25-45% |
| Binder | 10-30% |
| Liquefied Propellant | 5-15% |
| (that mixes with the compound) | |
| Aggregate or Fibrous Materials | 10-20% |
| (for use for acoustic ceilings) | |
| Anti-Foaming Agent | 1-5% |
| Suspension Agent | 5-10% |
| Sealant | 10-20% |

Also by way of a more specific example, the hardenable flowable material 16 of the present invention may have the following basic composition by percentage weight:

| Water | Quantity Sufficient |
|---|---|
| | to Achieve 100% |
| Calcium-Carbonate, Mica, and Clay | 25-70% |
| Polyvinyl Alcohol | 1-50% |
| Dimethyl Ether | 5-20% |
| Rubber or Polyethylene Particulates | 2-40% |
| (for use for acoustic ceilings) | |
| Anti-Foaming Agent | 1-10% |
| Carbonal | 1-20% |
| Acrylic Urethane | 5-40% |

Also by way of a more specific example, the hardenable flowable material 16 of the present invention may have the following basic composition by percentage weight:

| Water | Quantity Sufficient |
|---|---|
| | to Achieve 100% |
| Calcium-Carbonate, Mica, and Clay | 25-45% |
| Polyvinyl Alcohol | 10-30% |
| Dimethyl Ether | 5-15% |
| Fibrous Materials | 10-20% |
| (for use for acoustic ceilings) | |
| Anti-foaming Agent | 1-5% |
| Suspension Agent | 5-10% |
| Sealant | 10-20% |

The calcium-carbonate (limestone), mica, and clay of the filler are preferably in powder form. Furthermore, the composition of the material 16, as described directly above, may contain an anti-freeze (1-10%), such as ethylene glycol, or a fungicide (0.05-5%). In addition, in order to adjust the finished appearance of the material, an adhesive binder may be added in an appropriate amount, which will increase the hardness and body. Further, alcohol and/or solvent may be added to effect faster drying times.

The product of the present invention is water-based. This provides for easier cleanup in the situation where the material is sprayed inaccurately. The composition of the present invention also provides for a decreased drying time of drywall texture spray while avoiding the use of harmful or toxic chemicals, like aromatic or aliphatic hydrocarbons.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. A hardenable flowable substance for application to a surface to be coated, wherein the hardenable flowable substance is storable in a fluid-tight dispensing container and sprayable utilizing a propellant, the hardenable flowable substance comprising:
a liquid base; a filler selected to form an extender or bodifier for the resulting sprayable material;
an adhesive binder selected to adhere the resulting sprayable material to the surface;
an anti-foaming agent;
a suspension agent; and
a sprayable sealant, wherein the hardenable flowable substance forms a coat and the sprayable sealant generally seals the coat such that the coat can be directly painted on.

2. The hardenable flowable substance according to claim 1 further including fibrous materials selected to give the resulting sprayable material an irregular surface.

3. The hardenable flowable substance according to claim 2, wherein the fibrous materials are selected from the group consisting of polypropylene fibers, polyethylene fibers, plastic fibers, cotton fibers, natural fibers, and synthetic fibers.

4. The hardenable flowable substance according to claim 2, wherein the fibrous materials do not decompose in the presence of volatile organic compound (VOC) propellants.

5. The hardenable flowable substance according to claim 1, wherein the propellant is a volatile organic compound (VOC) propellant.

6. The hardenable flowable substance according to claim 1, wherein the sealant is selected from the group consisting of urethane-based, cellulose-based, acrylic-based, silicon-based, and mixtures thereof.

7. The hardenable flowable substance according to claim 1, wherein the sealant is acrylic urethane.

8. The hardenable flowable substance according to claim 1, having the following composition by percentage weight:
the liquid base of 10-60%;
the filler of 15-70%;
the adhesive binder of 1-50%;
the propellant of 5-20%;
the anti-foaming agent of 1-10%;
the suspension agent of 1-20%; and
the sealant of 540%.

9. The hardenable flowable substance according to claim 2, having the following composition by percentage weight:
the liquid base of 10-60%;
the filler of 15-70%;
the adhesive binder of 1-50%;
the propellant of 5-20%;
the fibrous materials of 2-40%;
the anti-foaming agent of 1-10%;
the suspension agent of 1-20%; and
the sealant of 540%.

10. The hardenable flowable substance according to claim 1, having the following composition by percentage weight:
the liquid base of 20-40%;
the filler of 25-45%;
the adhesive binder of 10-30%;
the propellant of 5-15%;
the anti-foaming agent of 1-5%;
the suspension agent of 5-10% and the sealant of 10-20%.

11. The hardenable flowable substance according to claim 2, having the following composition by percentage weight:
the liquid base of 20-40%;
the filler of 25-45%;
the adhesive binder of 10-30%;
the propellant of 5-15%;
the fibrous materials of 10-20%;
the anti-foaming agent of 1-5%;
the suspension agent of 5-10% and the sealant of 10-20%.

12. The hardenable flowable substance according to claim 1, further comprising a fungicide.

13. The hardenable flowable substance according to claim 1, further comprising an anti-freeze.

14. A system for dispensing a hardenable flowable substance sprayable utilizing a propellant for application to a surface to be coated, the system comprising:
a fluid-tight container, in which the hardenable flowable substance is stored; and
an actuator coupled to the fluid-tight container for selectively releasing the hardenable flowable substance in the form of a spray, wherein said hardenable flowable substance comprises
a liquid base,
a filler selected to form an extender or bodifier for the resulting sprayable material,
an adhesive binder selected to adhere the resulting sprayable material to the surface,
an anti-foaming agent,
a suspension agent, and
a sprayable sealant, wherein the hardenable flowable substance forms a coat and the sprayable sealant generally seals the coat such that the coat can be directly painted on.

15. The system for dispensing the hardenable flowable substance according to claim 14 further including fibrous materials selected to give the resulting sprayable material an irregular surface texture.

16. The system for dispensing the hardenable flowable substance according to claim 15, wherein the fibrous materials are selected from the group consisting of polypropylene fibers, polyethylene fibers, plastic fibers, cotton fibers, natural fibers, and synthetic fibers.

17. The system for dispensing the hardenable flowable substance according to claim 15, wherein the fibrous materials do not decompose in the presence of volatile organic compound (VOC) propellants.

18. The system for dispensing the hardenable flowable substance according to claim 14, wherein the propellant is a volatile organic compound (VOC) propellant.

19. The system for dispensing the hardenable flowable substance according to claim 14, wherein the sealant is selected from the group consisting of urethane-based, cellulose-based, acrylic-based, silicon-based, and mixtures thereof.

20. The system for dispensing the hardenable flowable substance according to claim 14, wherein the sealant is acrylic urethane.

21. The system for dispensing the hardenable flowable substance according to claim 14, having the following composition by percentage weight:
the liquid base of 10-60%;
the filler of 15-70%;
the adhesive binder of 1-50%;
the propellant of 5-20%;
the anti-foaming agent of 1-10%;
the suspension agent of 1-20%; and
the sealant of 5-40%.

22. The system for dispensing the hardenable flowable substance according to claim 15, having the following composition by percentage weight:
the liquid base of 10-60%;
the filler of 15-70%;
the adhesive binder of 1-50%;
the propellant of 5-20%;
the fibrous materials of 2-40%;
the anti-foaming agent of 1-10%;
the suspension agent of 1-20%; and
the sealant of 5-40%.

23. The system for dispensing the hardenable flowable substance according to claim 14, having the following composition by percentage weight:
the liquid base of 20-40%;
the filler of 25-45%;
the adhesive binder of 10-30%;
the propellant of 5-15%;
the anti-foaming agent of 1-5%;
the suspension agent of 5-10% and
the sealant of 10-20%.

24. The system for dispensing the hardenable flowable substance according to claim 15, having the following composition by percentage weight:
the liquid base of 20-40%;
the filler of 25-45%;
the adhesive binder of 10-30%;
the propellant of 5-15%;
the fibrous materials of 10-20%;
the anti-foaming agent of 1-5%;
the suspension agent of 5-10% and
the sealant of 10-20%.

25. The system for dispensing the hardenable flowable substance according to claim 11, the hardenable flowable substance further comprising a fungicide.

26. The system for dispensing the hardenable flowable substance according to claim 11, the hardenable flowable substance further comprising an anti-freeze.
